(19) United States
(12) Patent Application Publication
(10) Pub. No.: US 2011/0024671 A1
(43) Pub. Date: Feb. 3, 2011

(54) METHOD OF PRODUCING COMPOSITE MAGNETIC MATERIAL AND COMPOSITE MAGNETIC MATERIAL

(75) Inventors: Etsuo OTSUKI, Tokyo (JP); Shinya NAKANO, Tokyo (JP); Hirofumi KUROSAKI, Tokyo (JP)

Correspondence Address: HARNESS, DICKEY & PIERCE, P.L.C., P.O. BOX 828, BLOOMFIELD HILLS, MI, 48303, US

(73) Assignee: TOHO ZINC CO., LTD., Tokyo (JP)

(21) Appl. No.: 12/903,564

(22) Filed: Oct. 13, 2010

Related U.S. Application Data
(63) Continuation of application No. PCT/JP2009/057452, filed on Apr. 13, 2009.

(30) Foreign Application Priority Data
Apr. 15, 2008 (JP) 2008-106048

(51) Int. Cl. H01F 1/26; H01F 1/04

(52) U.S. Cl. 252/62.54; 252/62.55

(57) ABSTRACT

In one embodiment, a method is disclosed for producing a composite magnetic material, wherein the non-magnetic binder comprises a layered compound having an insulation property and the non-magnetic binder and soft magnetic metal powder is admixed with each other, the admixture is compacted to a desired shape, and the compact is heat-treated under predetermined condition to form a thin insulating layer made of the insulating layered compound on the surface of the soft magnetic metal powder, thereby producing the composite magnetic material having a withstand voltage of 20 V or more.

### CROSS REFERENCE TO RELATED APPLICATIONS

This is a Continuation Application of PCT Application No. PCT/JP2009/057452, filed Apr. 13, 2009, which was published under PCT Article 21(2) in Japanese.

This application is based upon and claims the benefit of priority from prior Japanese Patent Application No. 2008-106048, filed Apr. 15, 2008, the entire contents of which are incorporated herein by reference.

### BACKGROUND OF THE INVENTION

1. Field of the Invention

The present invention relates to a method of producing an inductor that is wire-wound to a metal-based soft magnetic alloy composite material applied for a power circuit of an electronic component, etc., and more particularly to, a method of producing a composite magnetic material such as dust core used as a core excellent in magnetic characteristics, and a composite magnetic material that is prepared by using the method.

2. Description of the Related Art

In recent years, along with needs for miniaturization and power-saving of electrical and electronic equipments, miniaturization and high efficiency of electronic components such as an inductor are required. Ferrite core has been mostly used as an inductor that is used in an electric and electronic circuit. However, in recent days, a dust core formed by compression molding of soft magnetic metal powder having high saturated magnetic flux density and an excellent DC superposition characteristic compared to ferrite has been used.

However, soft magnetic metal powder has low specific resistance because it has good conductivity. Thus, as having a huge eddy current loss, they cannot be used as they are. As a means to solve this problem, according to the literature “Physics of Strong Magnetic 3^{rd} Materials” (Part. 2, written by CHIKAZUMI SOSHIN, edition, Jul. 25, 1984, published by SHOKABO PUBLISHING Co., Ltd.; Chapter 8, page 375), non-magnetic binders are added to soft magnetic metal powder to form an insulating layer on surface of the soft magnetic metal powders so as to enhance an insulation property and withstand voltage. In this case, in order to obtain a high insulation property and high withstand voltage, it is necessary to increase the addition amount of non-magnetic binders.

However, when the addition amount of non-magnetic binders is increased, the insulating layer on the surface of soft magnetic metal powder becomes thick, and as a result problems arise in that magnetic characteristics such as magnetic permeability or magnetic loss (core loss) are impaired. To solve these problems, a method of coating the surface of soft magnetic metal powder with a glass material such as water glass has been suggested.

However, in case of a dust core, magnetic powder is deformed during compression-molded under high pressure, thereby impairing the magnetic characteristics. As such, to remove deformation caused by processing, heat treatment at high temperature is carried out. However, when it is heat-treated at high temperature, due to poor wettability between soft magnetic metal powder and glass, the molten glass becomes to have a particle shape on the surface of soft magnetic metal powder and gets isolated in the constitution. In addition, some part of the soft magnetic metal powder of which surface is not covered with glass is produced, and therefore it is problematic in that the desired insulation property and withstand voltage cannot be obtained. Meanwhile, when heat treatment temperature is lowered so as not to have particle-shape glass on the surface of soft magnetic metal powder, not all of the deformations that are caused by processing like compression molding cannot be removed, and as a result, magnetic characteristic such as magnetic permeability and core loss are impaired.

### BRIEF SUMMARY OF THE INVENTION

When the addition amount of non-magnetic binders is simply increased to ensure a high insulation property and high withstand voltage, the insulating layer formed on the surface of soft magnetic metal powder becomes thick, and as a result, magnetic characteristics such as magnetic permeability or core loss are impaired. On the other hand, when the addition amount of non-magnetic binders is lowered, magnetic permeability may be increased but an insulating layer cannot be formed so as to wrap around the surface of soft magnetic metal powders, and as a result, a low insulation property and low withstand voltage are obtained.

The present invention is to solve the problems described above, and has a purpose of providing a method of producing a composite magnetic material having high magnetic permeability and low core loss while maintaining high insulation property and high withstand voltage, and a composite magnetic material that is produced by the method.

In order to obtain high magnetic permeability and low core loss (magnetic characteristics) while maintaining an insulation property and withstand voltage (electrical characteristics), inventors studied intensively various combinations of soft magnetic materials and also a mixing method, etc. As a result, the invention described below is completed. Specifically, according to the invention, a composite magnetic material having a constitution in which a layered compound having an insulation property is admixed with soft magnetic metal powder and an insulating layer of the layered compound is formed on the surface of soft magnetic metal powder by heat treatment is provided. By adding a layered compound having an insulation property as a material for forming an insulating layer, sheet-like powder is obtained by delamination based on the structure of a layered compound and the powder is attached on the surface of soft magnetic metal powder. Thus, compacting density which is sufficient for compression molding is obtained and the magnetic characteristics like magnetic permeability, so that core loss can be surely obtained. In addition, a thin insulting layer may be formed so that the outer circumference of metal particles is covered by a layered compound, together with ceramics phase like sodium silicate, etc. that is produced according to the release of water of crystallization from silicon oxide or water glass, generated from decomposition of a silicone resin by heat treatment after compacting. As this insulating layer is made of oxides or nitrides, it will not be disrupted by heat treatment at high temperature after compression molding. Accordingly, the composite magnetic material can have an insulation property and withstand voltage. The invention as follows is accomplished based on these findings.

The method of producing a composite magnetic material that is related to the invention is characterized in that, regarding a method of producing a composite magnetic material for an inductor in which soft magnetic metal powder is bound with a non-magnetic binder; (a) the non-magnetic binder comprises a layered compound having an insulation property, wherein the non-magnetic binder and the soft magnetic metal powder are admixed with each other to delaminate the layered compound, thereby making the delaminated layered compound adhere to surface of the soft magnetic metal powder; (b) the admixture obtained from step (a) is compacted to a desired shape; and (c) the compact obtained from step (b) is heat-treated under predetermined condition to form a thin insulating layer made of the insulating layered compound on the surface of the soft magnetic metal powder, thereby producing the composite magnetic material having a withstand voltage of 20 V or more.

Furthermore, the composite magnetic material of the invention is a composite magnetic material for an inductor in which soft magnetic metal powder is bound with a non-magnetic binder, and it is characterized in that an outer circumference of particles constituting the soft magnetic metal powder is covered with a layered compound having an insulation property and it has withstand voltage of 20 V or more.

According to the invention, a dust core as a composite magnetic material having improved magnetic characteristics like magnetic permeability and core loess, etc. and an excellent insulation property and withstand voltage can be obtained.

By using the composite magnetic material that is obtained by the method of the invention, a short defect can be prevented even when an electric wire is in direct contact with a dust core. According to the invention, a case or a bobbin which is required for separating a dust core from a coil conductor is unnecessary, and therefore it is possible to achieve miniaturization of an inductor.

### BRIEF DESCRIPTION OF THE SEVERAL VIEWS OF THE DRAWING

FIG. 1 is a flow sheet showing a method of producing a composite magnetic material according to an embodiment of the invention;

FIG. 2A is a cross-sectional pattern diagram showing a change in the micro constitution of a composite magnetic material produced by using the method of the invention;

FIG. 2B is a cross-sectional pattern diagram showing a change in the micro constitution of a composite magnetic material produced by using a conventional method;

FIG. 3A is a front view showing an example of a toroidal form inductor;

FIG. 3B is a lateral view showing an example of a toroidal form inductor;

FIG. 4A is a front view showing an example of another type of the toroidal form inductor;

FIG. 4B is a lateral view showing an example of another type of the toroidal form inductor;

FIG. 5A is a disassembled lateral view showing components of a variant inductor before assembling;

FIG. 5B is a complete lateral view showing a variant inductor after assembling;

FIG. 6A is a plane view of a variant inductor;

FIG. 6B is a lateral view of a variant inductor; and

FIG. 6C is a front view of a variant inductor.

### DETAILED DESCRIPTION OF THE INVENTION

As a compacting process of compression-molding magnetic powders under high pressure is included in the process of manufacturing a dust core, deformation of magnetic powders is caused by processing, and therefore magnetic characteristics are deteriorated. In order to remove such deformation by processing, a heat treatment is carried out on a compact. Higher the temperature used for this heat treatment, removal ratio of deformation caused by processing is increased. However, according to a conventional method in which surface of magnetic powders is coated with a glass material like water glass, when it is heat-treated at high temperature, due to poor wettability between magnetic powders and glass, the molten glass becomes to have a particle shape on the surface of the magnetic powders and gets isolated in the constitution. In addition, some part of the magnetic powders of which surface is not covered with glass is produced, and therefore a desired insulation property and withstand voltage cannot be obtained.

Inventors intensively studied to ensure a desired insulation property and withstand voltage, and to obtain improved magnetic characteristics by effectively removing deformation of magnetic powder by processing. As a result, found that the surface of the magnetic powder can be effectively coated by a layered compound having an insulation property as a non-magnetic binder. The invention was achieved based on this finding, and by using layered oxide, etc. having an insulation property as a non-magnetic binder, high magnetic permeability and low core loss can be obtained even with high insulation property and high withstand voltage.

The method of producing a composite magnetic material that is related to the invention is characterized in that, (a) the non-magnetic binder comprises a layered compound having an insulation property, wherein the non-magnetic binder and the soft magnetic metal powder are admixed with each other to delaminate the layered compound, thereby making the delaminated layered compound adhere to surface of the soft magnetic metal powder; (b) the admixture obtained from step (a) is compacted to a desired shape; and (c) the compact obtained from step (b) is heat-treated under predetermined condition to form a thin insulating layer made of the insulating layered compound on surface of the soft magnetic metal powder, thereby producing the composite magnetic material having a withstand voltage of 20 V or more.

The insulating layered compound is preferably made of a layered oxide having an insulation property. Preferably, it is made of one or at least two selected from the group consisting of talc, montmorillonite and mica. Furthermore, the insulating layered compound is preferably made of a layered nitride having an insulation property, and more preferably is made of boron nitride. Still furthermore, the insulating layered compound may be a mixture in which at least two of a compound selected from the group consisting of a layered oxide having an insulation property and a layered nitride having an insulation property are mixed.

Hereinafter, various embodiments to carry out the invention will be described with respect to the attached drawings.

### (Manufacture of a Composite Magnetic Material)

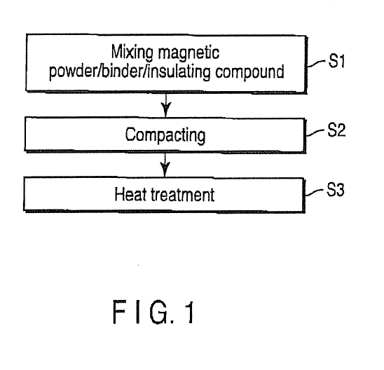

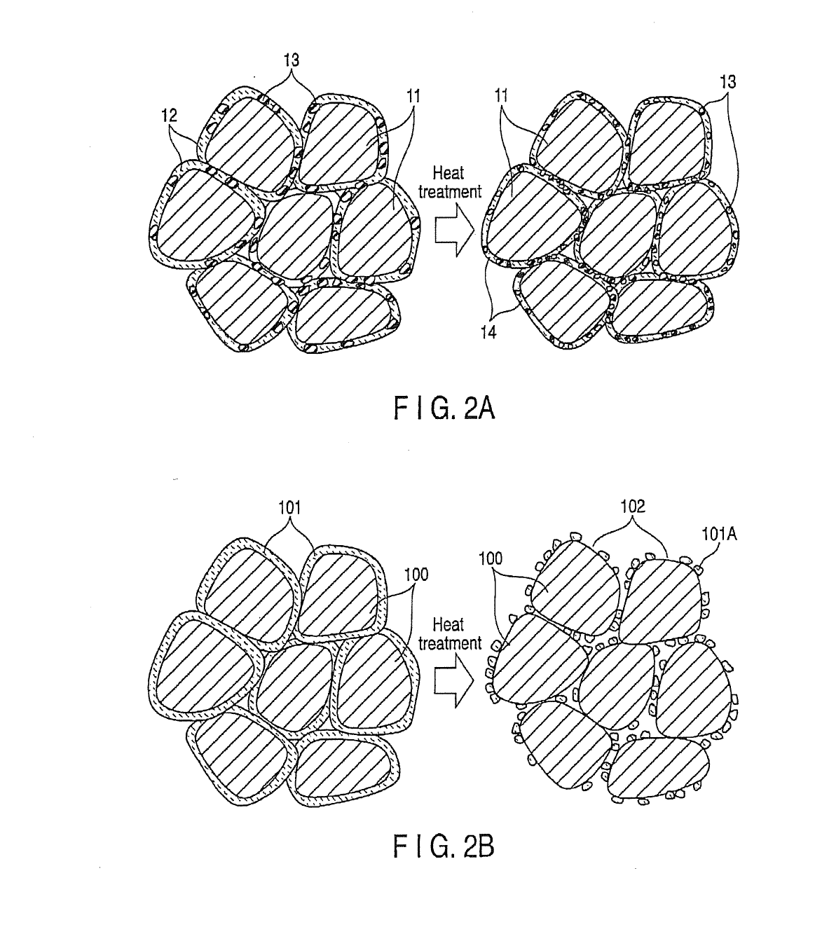

Manufacture of a dust core compact as a composite magnetic material using the method of the invention will be explained with reference to FIG. 1 and FIG. 2A.

First, soft magnetic metal powders 11, a compacting additive 12 and an insulating layered compound 13 are mixed in a predetermined blending ratio (step S1). The compacting additive 12 comprises one or at least two kinds selected from the group consisting of a silicone resin and ceramics. As for ceramics 12, so-called clay mineral (for example, kaolin, kibushi clay and bentonite) such as kaolinite, montmorillonite and the like, a liquid glass and a frit may be used.

As for an insulating layered compound 13, oxides or nitrides having an insulation property and their mixture may be used. As for the oxides having an insulation property, one or at least two kinds that are selected from a group consisting of talc, montmorillonite and mica may be used. Furthermore, as for the nitrides having an insulation property, boron nitride may be used.

A mixture of the magnetic powders/compacting additive is kneaded and granulated, and compacted into a desired shape using a compacting process machine (Tamagawa TTC-20) (step S2). In the invention, an insulating layered compound 13 is admixed with soft magnetic metal powders 11, together with a silicone resin or ceramics 12 as a non-magnetic binder, and as a result, structural delamination of the insulating layered compound 13 occurs to yield sheet-like powders, which are adhered on surface of the soft magnetic metal powders 11 together with the silicone resin or ceramics 12.

Subsequently, the compact is placed in an apparatus for heat treatment and heat-treated under a predetermined condition (step S3). For this heat treatment step S3, it is preferable that the heating temperature is 600 to 900° C. and the heating time is 60 to 180 minutes. When the heating temperature is less than 600° C., removal of deformation caused by processing is insufficient, and therefore the desired magnetic characteristics are not obtained. On the other hand, if the heating temperature is higher than 900° C., deterioration in loss characteristics is caused by a change in constitution. Thus, it is preferable to have the temperature range described above. Likewise, when the heating time is short like less than 60 minutes, removal of deformation caused by processing is insufficient, and when it is more than 180 minutes, a problem in productivity is caused. According to the invention, an insulating layered compound 13 is, together with a silicone resin or ceramics phase 14 which is generated from degradation of ceramics 12, adsorbed on soft magnetic metal powders 11 according to a heat treatment, thus surface of the soft magnetic metal powders 11 is covered with the insulating layered compound 13 and the ceramics phase 14. Furthermore, as the insulating layered compound 13 is introduced into the gaps between the particles of the soft magnetic metal powders 11 by the kneading and granulation process described above, insulation between the particles of soft magnetic metal powders can be obtained. Therefore, according to the invention, a composite magnetic material (i.e., a dust core) having high insulation property and high withstand voltage is obtained.

Then, the compact after the heat treatment is further immersed in a impregnated resin solution and vacuum-aspirated to have the compact impregnated with the resin under reduced pressure which is equal to or less than predetermined pressure. As a result, fine voids existing in a base are filled with the impregnated resin, and therefore the strength of the compact is enhanced. After the impregnation treatment, the compact may be subjected to a heat treatment under a predetermined condition to sufficiently cure the impregnated resin.

According to the descriptions above, a dust core compact for an inductor having an excellent insulation property is obtained.

Hereinafter, summary of the conventional production method will be given.

A silicone resin or water glass 101 is admixed with soft magnetic metal powders 100 to cover the surface of the soft magnetic metal powders. According to kneading with magnetic powders/silicone resin or glass water and drying, surface of the soft magnetic metal powders is covered with the silicone resin or water glass 101. The mixed powders are formed into a desired shape by using a compacting process, etc. Subsequently, the compact is subjected to a heat treatment under a predetermined condition. The heat treatment is to form ceramics phase 101A by melting and degradation of a silicone resin or water glass and to remove deformation of the compact caused by processing, and it has heating temperature of 600 to 900° C., and heating time of 60 to 180 minutes. When the heating temperature is low, removal of deformation caused by processing is insufficient, and therefore the desired magnetic characteristics are not obtained. On the other hand, if the heating temperature is too high, deterioration in loss characteristics is caused by a change in constitution of the non-magnetic binder described above. Thus, it is preferable to have the temperature range described above. Likewise, when the heating time is too short, removal of deformation caused by processing is insufficient, and when it is too long, a problem in productivity is caused. However, when the heat treatment is carried out at high temperature, as wettability of soft magnetic metal powders with glass is poor, glass 101A molten on the surface of soft magnetic metal powders becomes to have a particle shape and gets isolated in the constitution, and an exposed region 102 in which the surface of the soft magnetic metal powders is not covered with glass 101A is produced. When these exposed regions 102 are in contact with each other, no insulation among the soft magnetic metal powders particle 100 is obtained at the contact region, and as a result, the desired insulation property and withstand voltage may not be obtained.

### (Manufacture of Inductor)

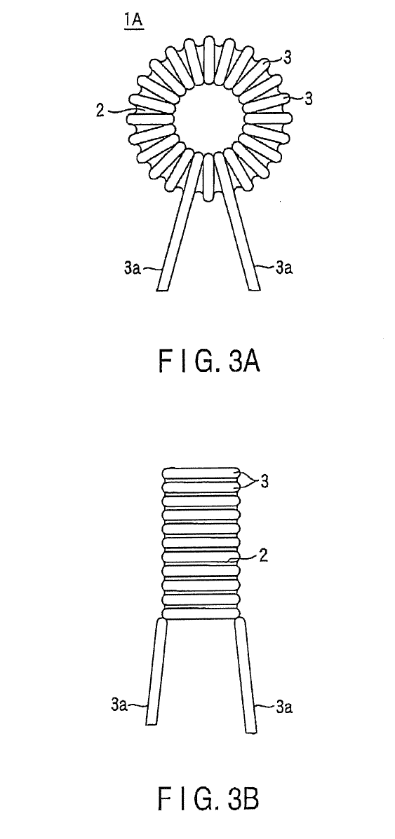

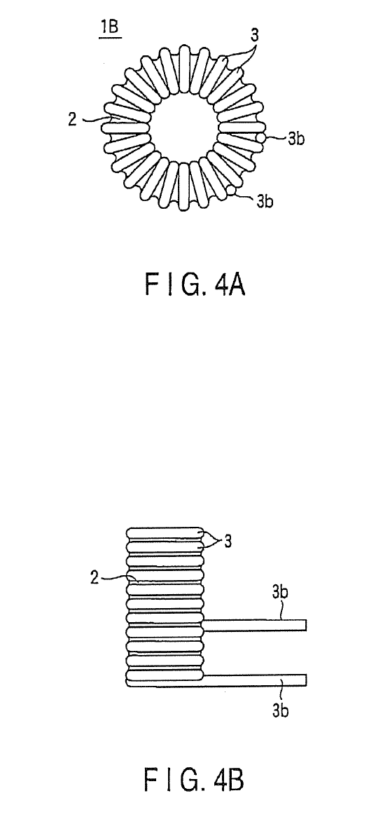

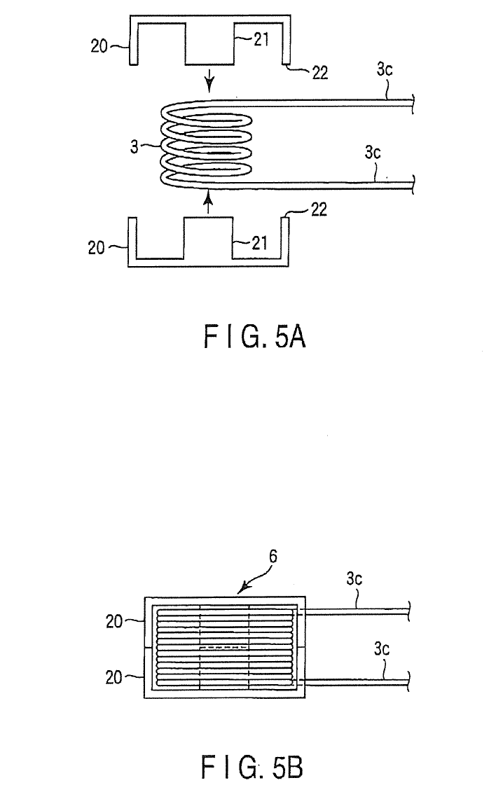

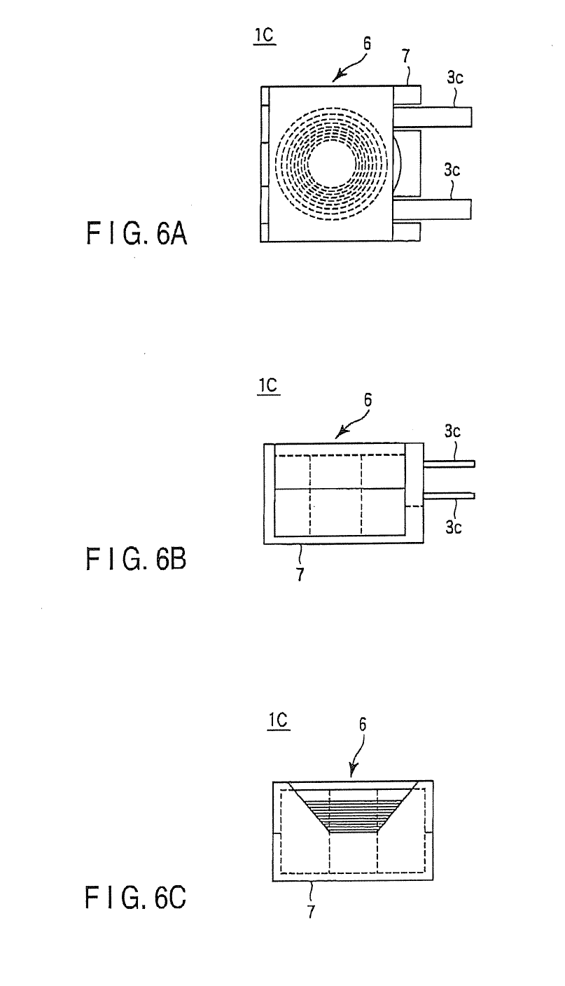

Next, manufacture of various inductors (coil) will be explained with reference to FIG. 3A, FIG. 3B, FIG. 4A, FIG. 4B, FIG. 5A, FIG. 5B, FIG. 6A, FIG. 6B and FIG. 6C.

FIG. 3A, FIG. 39, FIG. 4A and FIG. 4B show inductors 1A and 1B, respectively that are obtained by impregnating a compact 2 of a composite magnetic material (dust core), which is compacted to a toroidal shape and heat-treated, with a binder, and rolling a winding wire conductor 3 thereon. FIG. 3A and FIG. 3B show a vertical type coil (inductor) that is obtained by projecting both ends of a winding wire conductor 3 as a lead terminal 3a to the lateral direction of the compact 2 in a toroidal shape, and placing the lateral side of the compact 2 on a print substrate to be mounted. FIG. 4A and FIG. 4B show a horizontal type coil (inductor) that is obtained by projecting both ends of the winding wire conductor 3 as a lead terminal 3b to the lateral direction of the compact 2 of a toroidal shape, and placing the bottom of the compact 2 on a print substrate to be mounted.

The above-mentioned toroidal form inductors 1A and 1B are obtained by coating the whole compact 2 with an insulating resin by an immersion method, and then heating and drying it, and rolling up a winding wire conductor 3 thereon. Such toroidal type inductors 1A and 1B are mainly used as a chalk coil as a filter for prevention of noise that is generated at the time of switching of a thyristor application product, or for prevention of noise of a switching power.

Next, variant inductors (coil) will be explained with reference to FIG. 5A, FIG. 5B, FIG. 6A, FIG. 6B, and FIG. 6C.

First, a manufacture method for a variant inductor will be explained. The core compact 20 shown in FIG. 5A is integrally molded by a pressure compacting method, and has an outer circumferential portion 22 having “C” shape in the cross-section, and a cylindrical central portion 21. The cylindrical central portion 21 is arranged as spaced from the both lateral walls of the outer circumferential portion 22, and a certain space is formed for receiving a coil 3 between the lateral wall of the outer circumferential portion 22 and the cylindrical central portion 21. Such core compact 20 is prepared in two, and these are placed so as to face each other, and the central portions 21 of a pair of the core compacts 20 are inserted into the coil 3 which is previously coiling-processed. The end faces of the outer circumferential portion 22 of the core compact 20 are adhered to each other with an adhesive and the end faces of the central portion 21 of the core compact 20 are adhered to each other, respectively to form a coil assembly 6 shown in FIG. 5B. In such coil assembly 6, the cylindrical central portion 21 are nearly covered by the coil 3 and hidden, and the both ends of the coil 3 project from the outer circumferential portion 22 to the outside as lead terminals 3c of the positive and negative electrodes. Then, a pair of insulating cases 7 are adhered to both lateral sides of the coil assembly 6 as shown in FIG. 6A, FIG. 6B and FIG. 60, and the apertures in both sides of the coil assemblies 6 are blocked. This gives a variant inductor (coil) 10 shown in the drawing.

### EXAMPLES

Hereinafter, various embodiments and examples of the invention are explained in view of specific examples.

### Example 1

So-called sendust alloy having composition of Fe,Si-9.5% by mass, and Al-5.5% by mass was prepared by vacuum dissolution method, and with a mechanical alloying, alloy powders having an average particle diameter of about 80 μm were obtained. A layered compound having an insulation property and a non-magnetic binder were added in an amount of 0.5% by mass and 1.0% by mass, respectively, compared to the alloy powders. By using methyl ethyl ketone, wet mixing was carried out, and then mixed powders were obtained by granulation under heating and drying. In this regard, the layered compound having an insulation property and the non-magnetic binder were talc and a silicone resin, respectively. By using the mixed powders obtained, compression compacting was carried with pressure of 1.8 GPa to produce a toroidal core having an outer diameter of 13.4 mm, an inner diameter of 7.7 mm and thickness of 5.5 mm. After that, the core was heat-treated in air at 750° C. for 1 hour to prepare the sample of Sample No. 8, which corresponds to Example 1. Magnetic permeability of this sample was tested using a LCR meter with frequency of 100 kHz. By using a core loss measuring system (IWATSU SY-8617), core loss was measured with frequency of 100 kHz and applied magnetic field of 100 mT. By using a digital insulation tester, current which passes through the test sample was measured. From the applied voltage, insulation resistance was obtained. By applying AC current to the sample using a high voltage insulating tester and slowly increasing the voltage, the withstand voltage was measured.

### Comparative Examples 1 to 6, Reference Example 1

Sample Nos. 2 to 7 to which globular or crushed oxides having an insulation property were added were prepared, and their samples were taken as Comparative examples 1 to 6. Furthermore, Sample No. 1 to which no insulating layered compound is added was prepared, and taken as Reference example 1. Magnetic characteristics and electrical characteristics of Comparative examples 1 to 6 and Reference example 1 were measured and evaluated, respectively. The results are shown in Table 1, together with the result of Example 1. Herein, shape of the additives used for Sample Nos. 2 to 7 of the Comparative example was either globular or crushed form. Meanwhile, shape of the additives used for Sample No. 8 of the Example was either layered or plane-like form.

TABLE 1

| | | | Addition | Electrical | Withstand | | |
|---|---|---|---|---|---|---|---|
| Sample | | Insulating | amount | resistance | voltage | Magnetic | Core loss |
| No. | Division | additive | (% by mass) | (Ω · m) | (V) | permeability | (kW/m³) |
| 1 | Reference | — | — | 4 | — | 70 | 912 |
| | example 1 | | | | | | |
| 2 | Comparative | Alumina * | 0.5 | 68 | — | 55 | 1600 |
| | example 1 | | | | | | |
| 3 | Comparative | Alumina * | 1.5 | 3.0 × 10³ | 5 | 38 | 4850 |
| | example 2 | | | | | | |
| 4 | Comparative | Alumina ** | 0.5 | 132 | — | 58 | 1390 |
| | example 3 | | | | | | |
| 5 | Comparative | Alumina ** | 1.5 | 5.6 × 10³ | 10 | 34 | 3917 |
| | example 4 | | | | | | |
| 6 | Comparative | Colloidal | 0.5 | 970 | — | 54 | 1285 |
| | example 5 | silica | | | | | |
| 7 | Comparative | Colloidal | 1.5 | 8.2 × 10³ | 10 | 45 | 3722 |
| | example 6 | silica | | | | | |
| 8 | Example 1 | Talc | 0.5 | 1.3 × 10³ | 44 | 62 | 989 |

Note:
* indicates the particles with an average particle diameter of 1 μm, and
** indicates the particles with an average particle diameter of 0.3 μm.

As it is evident from Table 1, by adding an insulating layered compound, a desired insulation property and withstand voltage are attained, and also it is excellent in the characteristics of magnetic permeability and core loss.

Specifically, the electrical resistance value, which is an indicator of an insulation property, is higher in Example 1 compared to the specific resistance value of high-resistance type Ni—Zn ferrite that is generally used for an electric and electronic circuit (for example, 1×10³Ω·m).

In addition, the withstand voltage of Example 1 is much higher than 20 to 30 V, which is a minimum level required for normal operation of an inner circuit of an electrical and electronic equipment. As an example of an inner circuit of an electrical and electronic equipment, the operation voltage (i.e., secondary voltage) for a CPU installed in PC is around 0.9 V. In addition, the operation voltage (i.e., secondary voltage) for a connection circuit in a hard disk or a memory, etc. is around 1 to 12V.

In addition, the magnetic permeability of Example 1 is comparable to that of Reference example 1, and higher than all of Comparative examples 1 to 6.

In addition, the core loss of Example 1 is comparable to that of Reference example 1, and smaller than all of Comparative examples 1 to 6.

### Example 2

To the alloy powders having Fe,Si-9.5% by mass, and Al-5.5% by mass, which is the same composition as Example 1, an insulating layered compound and water glass as a binder were added, followed by wet-kneading with water. According to granulation under heating and drying, mixed powders were produced and the toroidal core which is identical to the Example 1 was produced. As an insulating layered compound, three kinds including bentonite, talc and mica were used. For each of these three kinds of an insulating layered compound, Sample Nos. 11 to 16 were produced (i.e., two for each compound), which are taken as Examples 2-1, 2-2, 2-3, 2-4, 2-5 and 2-6. Montmorillonite was included in the bentonite used. In addition, mica was finely pulverized using a pestle and mortar and then used. The toroidal core produced was subjected to the heat treatment by which it was maintained in air for 1 hour at temperature of 400° C. and 750° C., respectively. After that, the same test as Example 1 was carried out.

### Reference Examples 2 and 3

As Reference examples 2 and 3, samples of Sample Nos. 9 and 10 were prepared in which no insulating layered compound is added. After that, according to the same test as Example 1, evaluation was carried out. The results are shown in Table 2.

TABLE 2

| | | | Temperature | | | | |
|---|---|---|---|---|---|---|---|
| | | | for heat | Electrical | Withstand | | |
| Sample | | Insulating | treatment | resistance | voltage | Magnetic | Core loss |
| No. | Division | additive | (° C.) | (Ω · m) | (V) | permeability | (kW/m³) |
| 9 | Reference | — | 400 | 4 | — | 46 | 3000 |
| | example 2 | | | | | | |
| 10 | Reference | — | 750 | 7 | — | 60 | 1054 |
| | example 3 | | | | | | |
| 11 | Example 2-1 | Bentonite | 400 | 1.5 × 10⁴ | 42 | 37 | 4080 |
| 12 | Example 2-2 | Bentonite | 750 | 2.3 × 10⁶ | 43.5 | 57 | 1355 |
| 13 | Example 2-3 | Talc | 400 | 1.0 × 10⁴ | 51.2 | 35 | 3950 |
| 14 | Example 2-4 | Talc | 750 | 1.8 × 10⁶ | 53.9 | 55 | 1152 |
| 15 | Example 2-5 | Mica | 400 | 2.9 × 10⁴ | 45 | 36 | 4010 |
| 16 | Example 2-6 | Mica | 750 | 9.5 × 10⁵ | 45.8 | 56 | 1221 |

As it is evident from Table 2, when only water glass was used, the electrical resistance was low and withstand voltage was not obtained. However, by adding an insulating layered compound, a desired insulation property and withstand voltage are attained, and as a result, it is excellent in the characteristics of magnetic permeability and core loss.

Specifically, the electrical resistance (i.e., an insulation property) and the withstand voltage in each of Examples 2-1 to 2-6 exceed the evaluation level described above, and the magnetic permeability and core loss are comparable to those of Reference examples 2 and 3 or even better than them.

### Example 3

To the alloy powder having Fe,Si-9.5% by mass, and Al-5.5% by mass as shown in Example 1, boron nitride as an insulating layered compound and the binder shown in Table 3 were added and mixed to prepare the sample of Sample Nos. 18 to 20 and 22 to 24 which are the same as Example 1. The test which is the same as Example 1 was carried out, and each of these samples was taken as Examples 3-1 to 3-6.

### Reference Example 1

As Reference examples 1 and 3, a sample in which no boron nitride is added was prepared and then evaluated according to the same test as Example 1. The results are shown in Table 3.

TABLE 3

| | | | Addition amount | Electrical | Withstand | | |
|---|---|---|---|---|---|---|---|
| Sample | | | of boron nitride | resistance | voltage | Magnetic | Core loss |
| No. | Division | Binder | (% by mass) | (Ω · m) | (V) | permeability | (kW/m³) |
| 17 | Reference | Silicone | — | 4 | — | 70 | 912 |
| | example 1 | | | | | | |
| 18 | Example 3-1 | Silicone | 0.25 | 1.4 × 10⁶ | 40.8 | 67 | 996 |
| 19 | Example 3-2 | Silicone | 0.5 | 2.5 × 10⁶ | 43.4 | 64 | 1098 |
| 20 | Example 3-3 | Silicone | 0.75 | 5.7 × 10⁴ | 50.5 | 63 | 1225 |
| 21 | Reference | Water | — | 7 | — | 60 | 1054 |
| | example 3 | glass | | | | | |
| 22 | Example 3-4 | Water | 0.25 | 4.8 × 10⁴ | 50.4 | 59 | 1156 |
| | | glass | | | | | |
| 23 | Example 3-5 | Water | 0.5 | 2.0 × 10⁵ | 55.1 | 55 | 1320 |
| | | glass | | | | | |
| 24 | Example 3-6 | Water | 0.75 | 2.3 × 10⁵ | 60.3 | 54 | 1501 |
| | | glass | | | | | |

As it is evident from Table 3, by adding boron nitride as an insulating layered compound, an insulation property and withstand voltage are attained. Furthermore, according to the optimization of the addition amount of boron nitride, it was also found that excellent characteristics of magnetic permeability and core loss are obtained. Still furthermore, boron nitride was found to be effective for having a favorable molding property as it has a lubricating activity.

Specifically, the electrical resistance (i.e., an insulation property) and the withstand voltage in each of Examples 3-1 to 3-6 exceed the evaluation level described above, and the magnetic permeability and core loss are comparable to those of Reference examples 1 and 3 or even better than them.

### Example 4

To the alloy powder having Fe,Si-9.5% by mass, and Al-5.5% by mass as shown in Example 1, a mixture in which the oxide and the nitride blended in 1:1 ratio as an insulating layered compound and the binder were added and mixed to prepare the sample of Sample Nos. 25 and 26 which are the same as Example 1. The test which is the same as Example 1 was carried out, and each of these samples was taken as Examples 4-1 and 4-2. Meanwhile, a silicone resin was used as a binder. The results are shown in Table 4.

TABLE 4

| | | | Electrical | Withstand | | |
|---|---|---|---|---|---|---|
| Sample | | | resistance | voltage | Magnetic | Core loss |
| No. | Division | Insulating additive | (Ω · m) | (V) | permeability | (kW/m³) |
| 25 | Example 4-1 | Talc/Boron nitride | 8.6 × 10⁶ | 103 | 64 | 1132 |
| 26 | Example 4-2 | Bentonite/Boron nitride | 7.9 × 10⁶ | 95 | 62 | 1253 |

As it is evident from Table 4, even for a case in which a mixture of oxide and nitride is used as an insulating layered compound, a high insulation property and high withstand voltage are attained, and as a result, it was also found that it is excellent in the characteristics of magnetic permeability and core loss.

Specifically, the electrical resistance (i.e., an insulation property) and the withstand voltage in each of Examples 4-1 and 4-2 exceed the evaluation level described above, and the magnetic permeability and core loss are comparable to those of Reference example 1 or even better than that.

### Example 5

To the Fe powder, Fe—Ni alloy powder, Fe-6.5% Si alloy powder and rough composition of (Fe0.94Cr0.04)76(Si0.5B0.5)22C2 amorphous alloy powder, a layered compound having an insulation property and a binder were added and mixed to prepare the sample of Sample Nos. 27 to 34 which are the same as Example 1. The test which is the same as Example 1 was carried out. Meanwhile, for preparation of each sample, talc and boron nitride were used as a layered compound having an insulation property and a silicone resin was used as a binder. The resulting samples were taken as Examples 5-1 to 5-8, respectively. The results are shown in Table 5.

TABLE 5

| | | | | Electrical | Withstand | | |
|---|---|---|---|---|---|---|---|
| Sample | | Magnetic | Insulating | resistance | voltage | Magnetic | Core loss |
| No. | Division | powders | additive | (Ω · m) | (V) | permeability | (kW/m³) |
| 27 | Example 5-1 | Fe | Talc | 2.3 × 10³ | 64 | 73 | 4915 |
| 28 | Example 5-2 | Fe | Boron | 2.1 × 10³ | 58 | 71 | 5100 |
| | | | nitride | | | | |
| 29 | Example 5-3 | Fe-Ni | Talc | 4.5 × 10⁵ | 156 | 69 | 1451 |
| | | alloy | | | | | |
| 30 | Example 5-4 | Fe-Ni | Boron | 6.9 × 10⁴ | 142 | 68 | 1562 |
| | | alloy | nitride | | | | |
| 31 | Example 5-5 | Fe-6.5% Si | Talc | 7.2 × 10⁶ | 321 | 70 | 1621 |
| | | alloy | | | | | |
| 32 | Example 5-6 | Fe-6.5% Si | Boron | 5.9 × 10⁶ | 299 | 67 | 1720 |
| | | alloy | nitride | | | | |
| 33 | Example 5-7 | Amorphous | Talc | 1.3 × 10⁸ | 523 | 59 | 482 |
| | | alloy | | | | | |
| 34 | Example 5-8 | Amorphous | Boron | 9.1 × 10⁷ | 502 | 57 | 485 |
| | | alloy | nitride | | | | |

As it is evident from Table 5, by also adding an insulating layered compound to the soft magnetic metal powders, a desired insulation property and withstand voltage are attained. And as a result, it was also found that it is excellent in the characteristics of magnetic permeability and core loss.

Specifically, the electrical resistance (i.e., an insulation property) and the withstand voltage in each of Examples 5-1 to 5-8 exceed the evaluation level described above, and the magnetic permeability and core loss are comparable to those of Reference example 1 or even better than that.

The present invention is applicable for an inductor that is wire-wound to a metal-based soft magnetic alloy composite material used for a power circuit of an electronic component, etc.

What is claimed is:

1. A method of producing a composite magnetic material for an inductor, in which soft magnetic metal powder is bound with a non-magnetic binder, wherein
(a) the non-magnetic binder comprises a layered compound having an insulation property, wherein the non-magnetic binder and the soft magnetic metal powder are admixed with each other to delaminate the layered compound, thereby making the delaminated layered compound adhere to surface of the soft magnetic metal powder;
(b) the admixture obtained from step (a) is compacted to a desired shape; and
(c) the compact obtained from step (b) is heat-treated under predetermined condition to form a thin insulating layer made of the insulating layered compound on the surface of the soft magnetic metal powder, thereby producing the composite magnetic material having a withstand voltage of 20 V or more.

2. The method according to claim 1, wherein the insulating layered compound comprises a layered oxide having an insulation property.

3. The method according to claim 2, wherein the insulating layered compound comprises one or at least two selected from the group consisting of layered talc, montmorillonite and mica.

4. The method according to claim 1, wherein the insulating layered compound comprises a layered nitride having an insulation property.

5. The method according to claim 4, wherein the insulating layered compound comprises layered boron nitride.

6. The method according to claim 1, wherein the insulating layered compound comprises a mixture in which at least two of a compound selected from the group consisting of layered oxides having an insulation property and layered nitrides having an insulation property are mixed.

7. The method according to claim 1, wherein the soft magnetic metal powder is an alloy comprising Fe, Fe—Ni, Fe—Si, or Fe—Si—Al as a main component or an amorphous alloy comprising Fe—Si—B as a main component.

8. The method according to claim 1, wherein the non-magnetic binder further comprises, in addition to the insulating layered compound, the compact which comprises one or two selected from the group consisting of a silicone resin and ceramics.

9. A composite magnetic material for an inductor, in which soft magnetic metal powder is bound with a non-magnetic binder, wherein an outer circumference of particles constituting the soft magnetic metal powder is covered with a layered compound having an insulation property and the material has withstand voltage of 20 V or more.

10. The method according to claim 1, wherein the withstand voltage of the composite magnetic material is 40.8 V or more.
